(19) United States
(12) Patent Application Publication
(10) Pub. No.: US 2021/0248421 A1
(43) Pub. Date: Aug. 12, 2021

(54) CHANNEL INTERACTION NETWORKS FOR IMAGE CATEGORIZATION

(71) Applicant: Shenzhen Malong Technologies Co., Ltd., Shenzhen (CN)

(72) Inventors: Yu GAO, Shenzhen (CN); Xintong HAN, Shenzhen (CN); Weilin HUANG, Shenzhen (CN); Matthew Robert SCOTT, Shenzhen (CN)

(21) Appl. No.: 16/926,751

(22) Filed: Jul. 12, 2020

Related U.S. Application Data
(60) Provisional application No. 62/971,185, filed on Feb. 6, 2020.

(51) Int. Cl. G06K 9/62; G06K 9/00; G06N 3/08

(52) U.S. Cl. CPC G06K 9/6259; G06N 3/08; G06K 9/00771; G06K 9/6262

(57) ABSTRACT

This disclosure includes computer vision technologies for image categorization, such as used for product recognition. In one embodiment, the disclosed system uses a channel interaction network to learn stronger fine-grained features and to distinguish the subtle differences between two similar images. Additionally, the disclosed channel interaction network may be integrated into an existing feature extractor network to boost its performance for image categorization.

### CROSS-REFERENCE TO RELATED APPLICATIONS

This application claims the benefit of U.S. Provisional Application No. 62/971,185, filed Feb. 6, 2020, entitled “Channel Interaction Networks For Image Categorization,” the benefit of priority of which is hereby claimed, and which is incorporated by reference herein in its entirety.

### BACKGROUND

As an alternative to the traditional cashier-staffed checkout, self-checkout solutions become increasingly popular in the retail industry, particularly for grocery stores and supermarkets. Most self-checkout machines have the following components, including a lane light, a touchscreen monitor, a basket stand, a barcode scanner, a weighing scale, and a payment module. Using a self-checkout machine, a customer can scan product barcodes, weight products (such as fresh produce without barcodes) and select the product type on display, pay the products, bag the purchased products, and exit the store.

However, self-checkout machines are generally challenged to handle unlabeled products. Conventional systems may try to alphabetically or categorically enumerate all possible products in stock to assist users in selecting a correct one. Browsing and comparing a long list of products require intense attention, which may lead to customer frustration and errors.

Computer vision is a field for computers to gain a high-level understanding of digital images or videos. Computer vision and machine learning technologies potentially could provide a promising future for recognizing unlabeled or unpackaged products. However, even state-of-art computer vision technologies are still challenged to identify different sub-classes in a class due to the subtle inter-class differences, different sub-types in a type due to the subtle inter-type differences, different species in a genus due to the subtle inter-genus differences, etc. Advanced technologies are needed for fine-grained image categorization or classification, e.g., for product recognition in a retail solution.

### SUMMARY

This Summary is provided to introduce selected concepts that are further described below in the Detailed Description. This Summary is not intended to identify key features or essential features of the claimed subject matter, nor is it intended to be used as an aid in determining the scope of the claimed subject matter.

In general, aspects of this disclosure include a technical solution for image categorization, particularly for fine-grained image categorization. In various embodiments, the disclosed system uses a channel interaction network (CIN), which models the channel-wise interplay both within an image and across images. Specifically, a self-channel interaction (SCI) module is used in the CIN to learn the complementary features from the correlated channels in an image. Resultantly, the CIN is trained to yield more effective fine-grained features to represent the image. Furthermore, given an image pair, a contrastive channel interaction (CCI) module is used in the CIN to model the cross-sample channel interaction with a metric learning framework. Resultantly, the CIN is trained to distinguish the subtle visual differences between the image pair. Accordingly, the disclosed technologies may be used for image categorization, particularly for fine-grained image categorization, such as recognizing products not only in different classes but in different sub-classes with nuanced differences.

In various aspects, systems, methods, and computer-readable storage devices are provided to improve a computing system's ability for image categorization and corresponding CV applications (e.g., product recognition) in general. Specifically, one aspect of the technologies described herein is to improve a computing system's performance for image categorization based on the channel information. Another aspect of the technologies described herein is to provide a flexible CIN that can be integrated into existing feature extractor networks to boost their performance for image categorization.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The technologies described herein are illustrated by way of example and not limited in the accompanying figures in which like reference numerals indicate similar elements and in which:

FIG. 1 is a block diagram of an exemplary system for image categorization and an exemplary operating environment for the exemplary system, in accordance with at least one aspect of the technologies described herein;

FIG. 2 are various images illustrating a form of visualization of the correlation between channels and local semantics, in accordance with at least one aspect of the technologies described herein;

FIG. 3 is a block diagram of an exemplary channel interaction network, in accordance with at least one aspect of the technologies described herein;

FIG. 4 are various images illustrating a form of visualization of the relationship between a referred channel with other channels in a self-channel interaction module, in accordance with at least one aspect of the technologies described herein;

FIG. 5 are various images illustrating a form of visualization of respective results of a self-channel interaction module and a contrastive channel interaction module, in accordance with at least one aspect of the technologies described herein;

FIG. 6 is a flow diagram illustrating an exemplary process of training and operating a channel interaction network, in accordance with at least one aspect of the technologies described herein; and

FIG. 7 is a block diagram of an exemplary computing environment suitable for use in implementing various aspects of the technologies described herein.

### DETAILED DESCRIPTION

The various technologies described herein are set forth with sufficient specificity to meet statutory requirements. However, the description itself is not intended to limit the scope of this disclosure. Instead, the inventors have contemplated that the claimed subject matter might also be embodied in other ways, to include different steps or combinations of steps similar to the ones described in this document, in conjunction with other present or future technologies. Moreover, although the term “step” or “block” may be used herein to connote different elements of methods employed, the terms should not be interpreted as implying any particular order among or between various steps herein disclosed unless and except when the order of individual steps is explicitly described. Further, the term “based on” generally denotes that the succedent condition is used in performing the precedent action.

Self-checkout machines are generally challenged to process unlabeled products. Conventional systems may try to alphabetically or categorically enumerate many potential products to assist users in selecting a correct product. Browsing and comparing a long list of products require intense attention, which may lead to customer frustration and errors.

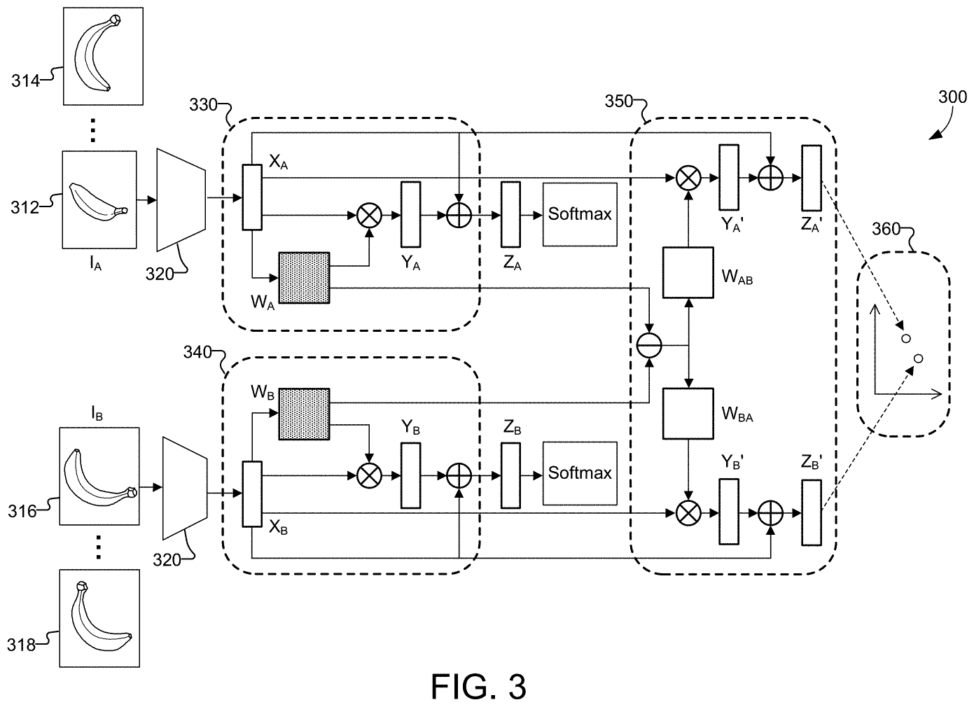

Computer vision and machine learning technologies potentially could provide a promising future for recognizing unlabeled products. However, even state-of-art computer vision technologies are still challenged to differentiate two products with subtle visual differences, such as between the Latundan banana and the Cavendish banana, as depicted in FIG. 3. More advanced technologies are needed for fine-grained image categorization, e.g., for product recognition in a retail solution.

The disclosed technologies herein can be applied in various computer vision tasks, such as ProductAI®, by Malong Technologies, which provides state-of-the-art APIs and embedded systems for visual product recognition. ProductAI® enables a machine to “see” products like a person, and recognize them holistically, with or without the need for barcodes. The disclosed technologies further boost the utility and effectiveness of ProductAI® for high-performance product detection and product image categorization. Further, the disclosed technologies can also improve other applications using image categorization, such as automatic driving or face recognition.

A high-level understanding of image similarities is a key CV problem. Images are typically embedded in a feature vector space, in which the distance between two embeddings represents their relative similarity or dissimilarity. Such vector space representations are used in CV applications such as image retrieval, categorization, or visualizations. This disclosure introduced an effective model to pull a pair of images in the same class (a.k.a. a positive pair) close to each other in the feature vector space while pushing away a pair of images in different classes (a.k.a. a negative pair) from each other in the feature vector space.

At a high level, aspects of this disclosure include a technical solution for image categorization, particularly for fine-grained image categorization. In various embodiments, the disclosed system exploits the rich relationships between channels as different channels correspond to different semantics. Specifically, the disclosed system uses a channel interaction network (CIN), which models the channel-wise interplay both within an image and across images. A self-channel interaction (SCI) module is used in the CIN to learn the complementary features from the correlated channels in an image. Resultantly, the CIN is trained to yield more effective fine-grained features to represent the image. Furthermore, given an image pair, a contrastive channel interaction (CCI) module is used in the CIN to model the cross-sample channel interaction with a metric learning framework. Resultantly, the CIN is trained to distinguish the subtle visual differences between the image pair. Accordingly, the disclosed technologies may be used for image categorization, particularly for fine-grained image categorization, such as recognizing products not only in different classes but in different sub-classes with nuanced differences.

The disclosed technologies can build powerful fine-grained feature representations for fine-grained image categorization. Unlike some methods using second or higher-order information for direct classification, the disclosed technologies compute second-order statistics between different channels, which are then used jointly with the original features to capture the channel-wise complementary information, resulting in more discriminative deep representations.

The disclosed technologies employ visual attention to capture the subtle inter-class differences in fine-grained image categorization. Hard-attention-based methods usually detect local regions and then crop them out from the original image. A common limitation of those conventional methods is that each cropped region requires an extra feedforward operation. Conversely, soft attention methods can be regarded as imposing a soft mask on the feature maps, by only using a single feedforward stage. Self-attention was proposed and applied in machine translation, and self-attention is similar to soft attention. Additionally, the non-local block method is highly related to the self-attention method but captures long-range dependencies in the space-time dimension in images and videos. In contrast to those self-attention-based methods, the disclosed technologies exploit the interactions between channels to discover the channel-wise complementary information rather than mining the closely related channels. Moreover, a contrastive channel interaction module is disclosed to model cross-sample channel interactions.

The disclosed technologies employ deep metric learning, which aims to learn a feature embedding for better measuring the similarities between image pairs. Specifically, the distance of positive pairs are encouraged to become closer, and the distance of positive pairs are encouraged to become farther. Compared with softmax loss used in conventional classification networks, deep metric learning can embed the samples into a low-dimensional space capturing high intra-class variance, which is more suitable for fine-grained image categorization. The disclosed network models the interplay between different channels explicitly to extract the discriminative features. Further, the disclosed network uses a novel contrastive channel interaction module to emphasize the differences between contrastive samples.

Disclosed is a lightweight model that can be trained more effectively in one stage. The new model is flexible and can be seamlessly integrated into existing networks to boost their performance, e.g., for image categorization. Resultantly, the disclosed technologies increase the utility and effectiveness of ProductAI® for high-performance image retrieval and auto-tagging for products, such as fashion, furniture, textiles, wine, food, and other retail products.

In summary, the disclosed CIN significantly improves CV technologies for fine-grained image categorization. The CIN learns complementary channel information in an image via an SCI module. Further, the CIN pulls positive image pairs closer while pushes negative image pairs away via a CCI module, which exploits channel correlations between samples. This network can be trained end-to-end in one stage requiring no bounding box or part annotations and without the need for multi-stage training and testing. Further, various experiments are conducted on multiple publicly available benchmarks, where the disclosed system outperforms many state-of-the-art approaches. This is also discussed in the experiments section below.

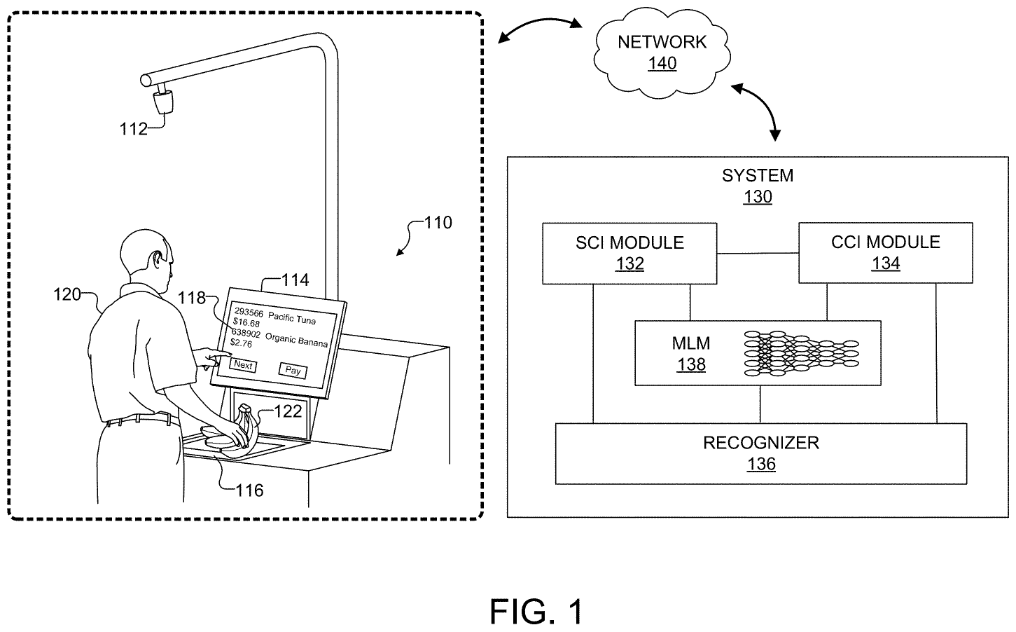

Having briefly described an overview of aspects of the technologies described herein, referring now to FIG. 1, which is a schematic representation illustrating an exemplary system in an exemplary operating environment. In this operating environment, apparatus 110 includes, among many components not shown, camera 112, display 114, and scanner 116. Camera 112 is configured to capture the product over scanner 116, e.g., product 122, and display 114 is configured to present product information 118 related to product 122. User 120 may use apparatus 110 for self-checkout or assist others in checking out products. Apparatus 110 is merely one example of a suitable computing environment and is not intended to suggest any limitation as to the scope of use or functionality of aspects of the technologies described herein. Neither should apparatus 110 be interpreted as having any dependency or requirement relating to any one component nor any combination of components illustrated.

At a high level, system 130 is configured to follow at least one aspect of the technologies described herein for image categorization. In addition to other components not shown, system 130 includes SCI module 132, CCI module 134, recognizer 136, and machine learning module (MLM) 138, operatively coupled with each other to perform various functions related to image categorization.

In this embodiment, system 130 is configured to enable machines empowered by ProductAI® (e.g., apparatus 110) to recognize products without the need for scanning barcodes. In one embodiment, system 130 may receive an image of product 122. Subsequently, system 130 can classify the product image to a specific class and return a corresponding class identifier or product identifier. Accordingly, apparatus 110 may present product information 118 to user 120 based on the product identifier.

In some embodiments, system 130 is installed in apparatus 110. In some embodiments, system 130 is operatively coupled to apparatus 110, e.g., via communication network 140, which may include, without limitation, a local area network (LAN) or a wide area network (WAN), e.g., a 4G or 5G cellular network. It should be noted that apparatus 110 here merely form one exemplary operating environment for system 130, which follows at least one aspect of the technologies described herein. System 130 is not intended to suggest any limitation as to the scope of use or functionality of all aspects of the technologies described herein. Neither should this system be interpreted as having any dependency or requirement relating to any one component nor any combination of components illustrated.

In various embodiments, system 130 includes a CIN, which further includes SCI module 132 and CCI module 134. SCI module 132 is configured to learn image features from the intra-sample channel interactions within an image. In contrast, CCI module 134 is configured to learn image features from the cross-sample channel interactions between a pair of images. Consequently, recognizer 136 can recognize a product in an image based on the fine-grained image features determined by the CIN.

To extract image features, system 130 may use a machine learning model implemented via, e.g., MLM 138, which may include one or more neural networks in various embodiments. As used herein, a neural network comprises at least three operational layers, such as an input layer, a hidden layer, and an output layer. Each layer comprises neurons. The input layer neurons pass data to neurons in the hidden layer. Neurons in the hidden layer pass data to neurons in the output layer. The output layer then produces a classification. Different types of layers and networks connect neurons in different ways.

Every neuron has weights, an output, and an activation function that defines the output of the neuron based on input and the weights. The weights are the adjustable parameters that cause a network to produce the correct output. The weights are adjusted during training. Once trained, the weight associated with a given neuron can remain fixed. The other data passing between neurons can change in response to a given input (e.g., image).

A neural network may include more than three layers. Neural networks with more than one hidden layer may be called deep neural networks. Example neural networks that may be used with aspects of the technology described herein include, but are not limited to, multi-layer perceptron (MLP) networks, convolutional neural networks (CNN), recursive neural networks, recurrent neural networks, and long short-term memory (LSTM) (which is a type of recursive neural network). Some embodiments described herein use a convolutional neural network, but aspects of the technology are applicable to other types of multi-layer machine classification technology.

During the training phase, training data (e.g., positive and negative pairs of images) are used to train MLM 138, wherein both SCI module 132 and CCI module 134 are utilized for training the whole CIN. During the inference phrase, however, CCI module 134 may be retired in some embodiments, and discriminative images features generated from SCI module 132 are used for image categorization. More details are described in connection with FIG. 3 below.

Although examples are described herein with respect to using neural networks, and specifically convolutional neural networks in network 300 in FIG. 3, this is not intended to be limiting. For example, and without limitation, MLM 138 may include any type of machine learning model, such as a machine learning model(s) using linear regression, logistic regression, decision trees, support vector machines (SVM), Naïve Bayes, k-nearest neighbor (KNN), K means clustering, random forest, dimensionality reduction algorithms, gradient boosting algorithms, neural networks (e.g., auto-encoders, convolutional, recurrent, perceptrons, long/short term memory/LSTM, Hopfield, Boltzmann, deep belief, deconvolutional, generative adversarial, liquid state machine, etc.), or other types of machine learning models.

It should be understood that this arrangement in apparatus 110 is set forth only as an example. Other arrangements and elements (e.g., machines, networks, interfaces, functions, orders, and grouping of functions, etc.) can be used in addition to or instead of those shown, and some elements may be omitted altogether for the sake of clarity. Further, many of the elements described herein are functional entities that may be implemented as discrete or distributed components or in conjunction with other components, and any suitable combination and location. Further, various functions described herein as being performed by an entity may be carried out by hardware, firmware, or software. For instance, some functions may be carried out by a processor executing instructions stored in memory.

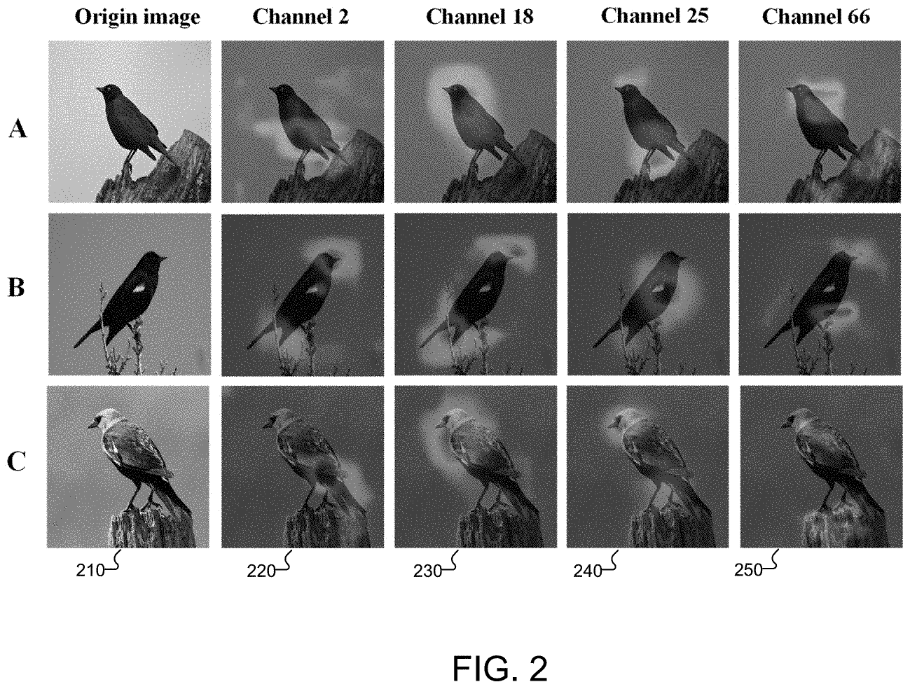

Now referring to FIG. 2, which has various images illustrating a form of visualization of the correlation between channels and local semantics in respective images. Going beyond conventional image classification that recognizes basic-level categories, fine-grained categories are much more challenging to be identified with CV technologies due to the subtle differences among fine-grained categories. Many of such subtle differences can only be effectively distinguished by concentrating on discriminative local parts. For instance, image features at respective wings and heads may be used to distinguish the three bird species in FIG. 2.

People tend to distinguish images by focusing on their specific distinctions. For instance, when comparing two images A and B in column 210, it is easy to identify the difference of wings between them. Specifically, the bird in A has pure black wings while the bird in B has a red dot on its black wings. However, when images of A and C are compared, more attention should be directed to the regions of heads. Specifically, the head of the bird in A is in black while the head of the bird in C is in orange.

Various images in columns 220, 230, 240, and 250 illustrate a form of visualization of channel activations. Specifically, highlighted regions correspond to respective activated channels in respective images. As shown in FIG. 2, different channels often correspond to different visual patterns or local semantics. For example, for image C, channel 2 generally corresponds to the bird's wing, while channel 18 generally corresponds to the bird's shoulder. Similarly, channel 25 generally corresponds to the bird's head, while channel 66 generally corresponds to the bird's feet. Further, as shown in FIG. 2, most of the channels are semantically complementary to each other. For example, the corresponding local semantics of channels 2, 18, 25, and 66 (i.e., wing, shoulder, head, feet) for image C, as discussed previously, are semantically complementary to each other.

To this end, the disclosed CIN aims to discover the complementary channel information for each channel and then utilize the complementary channel information to capture the discriminative features of an image. Specifically, an SCI module is used to explicitly model the relationships between various channels to discover such channel-wise complementary information. Such complementary information can often cooperatively contribute to the referred channel, making the channel more discriminative. Such channel-wise complementary information has not been fully explored in the existing CV technologies. Instead, existing methods usually apply the channel interplay for direct classification or merely mine the most closely related channels. Meanwhile, a CCI module is used to capture the subtle differences between a pair of images. Further, metric learning is incorporated into the CIN to model the inter-sample or cross-sample channel interactions, which is generally neglected by most of the existing methods.

Now referring to FIG. 3, which illustrates an exemplary channel interaction network, network 300. Network 300 may be used for fine-grained image categorization. At a high-level, given an image pair, e.g., image 312 and image 316, or image 314 and image 318, the image pair is first processed by backbone 320, e.g., ResNet-50, which generates respective convolutional feature maps for the image pair. Next, SCI module 330 and SCI module 340 are configured to compute channel-wise complementary information for each channel on respective feature maps. As discussed in further detail below, an SCI module is designed to model the correlations or interplay between different channels within an image or a feature map of the image. Advantageously, the SCI module can capture the channel-wise complementary information for each channel, which enhances the discriminative features learned by each channel. The resulting complementary information discovered in the SCI (e.g., Y_{A} or Y_{B}) will be aggregated with the discriminate features from an original feature map (e.g., X_{A} or X_{B}) to form the final feature (e.g., Z_{A} or Z_{B}) to represent the input image.

As discussed in further detail below, a CCI module is designed to dynamically identify the distinct regions from two compared images, allowing network 300 to focus on such distinctive regions for better categorization. In this embodiment, CCI module 350 is designed with a contrastive loss to model the channel-wise relationships between two images, e.g., between image 312 and image 316, or between image 314 and image 318. In various embodiments, the input images have image-level labels only. In this example, image 312 (a Latundan banana) and image 316 (a Cavendish banana) form a negative pair because they are in different classes. In contrast, image 314 (a Cavendish banana) and image 318 (a Cavendish banana) form a positive pair because they are in the same class. Further, SCI module 330, CCI module 350, and backbone 320 may be jointly optimized with a loss function, as discussed below. In this way, network 300 can be trained end-to-end in one stage, and thus is more lightweight than many two-stage methods, and also is readily applicable to other convolution neural networks.

Network 300 may include any number of layers. In various embodiments, SCI module 330, CCI module 350, or backbone 320, may be implemented as one or more layers in network 300. The objective of one type of layers (e.g., Convolutional, Relu, and Pool) may be configured to extract features of the input volume, while the objective of another type of layers (e.g., FC and Softmax) may be configured to classify an input based on the extracted features.

An input layer of network 300 may hold values associated with an instance. For example, when the instance is an image, the input layer may hold values representative of the raw pixel values of the image as a volume, such as W×H×C (a width, W; a height, H; and color channels, C (e.g., RGB)), or a batch size, B.

One or more layers in network 300 may include convolutional layers. The convolutional layers may compute the output of neurons that are connected to local regions in an input layer (e.g., the input layer), each neuron computing a dot product between their weights and a small region they are connected to in the input volume. In a convolutional process, a filter, a kernel, or a feature detector includes a small matrix used for feature detection. Convolved features, activation maps, or feature maps are the output volume formed by sliding the filter over the image and computing the dot product. An exemplary result of a convolutional layer can be another volume, with one of the dimensions based on the number of filters applied (e.g., the width, the height, and the number of filters, F, such as W×H×F, if F were the number of filters).

One or more of the layers may include a rectified linear unit (ReLU) layer. The ReLU layer(s) may apply an elementwise activation function, such as the max (0, x), thresholding at zero, for example, which turns negative values to zeros (thresholding at zero). The resulting volume of a ReLU layer may be the same as the volume of the input of the ReLU layer. In some embodiments, this layer does not change the size of the volume, and there are no hyperparameters.

One or more of the layers may include a pool or pooling layer. A pooling layer performs a function to reduce the spatial dimensions of the input and control overfitting. There are different functions, such as Max pooling, average pooling, or L2-norm pooling. In some embodiments, max pooling is used, which only takes the most important part (e.g., the value of the brightest pixel) of the input volume. By way of example, a pooling layer may perform a down-sampling operation along the spatial dimensions (e.g., the height and the width), which may result in a smaller volume than the input of the pooling layer (e.g., 16×16×12 from the 32×32×12 input volume). In some embodiments, the convolutional network may not include any pooling layers. Instead, strided convolution layers may be used in place of pooling layers.

One or more of the layers may include a fully connected (FC) layer. An FC layer connects every neuron in one layer to every neuron in another layer. The last FC layer normally uses an activation function (e.g., Softmax) for classifying the generated features of the input volume into various classes based on the training dataset. The resulting volume can take the shape of “1×1×number of classes.”

Further, calculating the length or magnitude of vectors is often required either directly as a regularization method in machine learning, or as part of broader vector or matrix operations. The length of the vector is referred to as the vector norm or the vector's magnitude. The L1 norm is calculated as the sum of the absolute values of the vector. The L2 norm is calculated as the square root of the sum of the squared vector values. The max norm is calculated as the maximum vector values.

As discussed previously, some of the layers may include parameters (e.g., weights or biases), such as a convolutional layer, while others may not, such as the ReLU layers and pooling layers, for example. In various embodiments, the parameters may be learned or updated during training. Further, some of the layers may include additional hyper-parameters (e.g., learning rate, stride, epochs, kernel size, number of filters, type of pooling for pooling layers, etc.), such as a convolutional layer or a pooling layer, while other layers may not, such as a ReLU layer. Various activation functions may be used, including but not limited to, ReLU, leaky ReLU, sigmoid, hyperbolic tangent (tan h), exponential linear unit (ELU), etc. The parameters, hyper-parameters, or activation functions are not to be limited and may differ depending on the embodiment.

Although input layers, convolutional layers, pooling layers, ReLU layers, and FC layers are discussed herein, this is not intended to be limiting. For example, additional or alternative layers, such as normalization layers, softmax layers, or other layer types, may be used in backbone 320.

Different orders and numbers of the layers of network 300 may be used depending on the embodiment. For example, a particular number of layers arranged in a particular order may be configured for one type of CV technologies (e.g., ProductAI®), whereas a different number of layers in a different order may be configured for another type of CV technologies (e.g., autonomous driving). In other words, the order and number of layers of the convolutional network are not limited to any one architecture.

In various embodiments, network 300 may be trained with labeled images using multiple iterations until the value of a loss function(s) of the machine learning model is below a threshold loss value. One or more loss functions may be used to measure errors in the predictions of the machine learning model using ground truth values.

The number of epochs is a hyperparameter that defines the number iterations that the learning algorithm will work through the entire training dataset. One epoch means that each sample in the training dataset has had an opportunity to update the internal model parameters. The number of epochs is traditionally large, often hundreds or thousands, allowing the learning algorithm to run until the error from the model has been sufficiently minimized.

A training dataset typically comprises many samples. A sample may also be called an instance, an observation, an input vector, or a feature vector. In various embodiments, a pair of samples may be used for training. A positive pair refers to a pair of images sharing the same class/category/label/etc., or the relationship between their respective classes being within a predetermined threshold/criterion/etc. Conversely, a negative pair refers to a pair of images having different labels/classes/categories/etc., or the relationship between their respective labels being beyond a predetermined threshold/criterion/etc.

In various embodiments, an epoch includes one or more batches. When all training samples are used to create one batch, the learning algorithm is called batch gradient descent. When the batch is the size of one sample, the learning algorithm is called stochastic gradient descent. When the batch size is more than one sample and less than the size of the training dataset, the learning algorithm is called mini-batch gradient descent.

Mini-batch gradient descent is a variation of the gradient descent algorithm that splits the training dataset into small batches that are used to calculate model error and update the learning model coefficients. Mini-batch gradient descent seeks to find a balance between the robustness of stochastic gradient descent and the efficiency of batch gradient descent.

The mini-batch size, or the batch size for brevity, is a hyperparameter that defines the number of samples to work through before updating the internal model parameters, which is often chosen as a power of two that fits the memory requirements of the GPU or CPU hardware like 32, 64, 128, 256, and so on. Small values for the batch size are believed to enable the learning process to converge quickly at the cost of noise in the training process, while large values may offer more accurate estimates of the error gradient. In various embodiments, a default batch size of 32, 64, or 128 is used.

In summary, the batch size and number of epochs for a learning algorithm are both hyperparameters for the learning algorithm, e.g., parameters for the learning process, not internal model parameters found by the learning process. Batch size is a number of samples processed before the model is updated. The number of epochs is the number of complete passes or iterations through the training dataset. In various embodiments, the batch size and number of epochs are preset for the learning model. The size of a batch must be more than or equal to one and less than or equal to the number of samples in the training dataset. The number of epochs can be set to an integer value between one and infinity.

Referring back to the self-channel interaction module, SCI module 330 and SCI module 340 are exemplary self-channel interaction modules. SCI module 330 and SCI module 340 are designed to extract channel-wise interaction relationships within an image or feature map, specifically complementary channel information, and encode them into the original features for fine-grained classification. In contrast, some existing systems tend only to highlight the most distinct feature channels for fine-grained classification. However, those systems focusing on the most discriminate channels might not be able to take the full advantage of useful information encoded in all channels. As discussed in connection with FIG. 2 previously, richer knowledge, including differential features or complementary information, is encoded in the feature channels. Interestingly, many channels are complementary to each other. The self-channel interaction module is designed to explore such rich knowledge from all channels, including how they interact with each other.

In various embodiments, given an image I, let X′ϵ [symbol] ^{w×h×c} denote the input feature map processed by the backbone, where w, h and c indicate the height, width, and the number of channels. An SCI module reshapes the input feature map X′ to Xϵ [symbol] ^{c×l}, 1=w×h, then generates feature Y, e.g., based on Eq. 1, where Wϵ [symbol] ^{c×c} denotes the SCI weight matrix, which can be computed according to Eq. 3.

Y=WXϵ [symbol] ^{c×l} (Eq. 1)

In terms of the SCI weight matrix, in one embodiment, a bilinear matrix, XX^{T} is obtained based on a bilinear operation between X and X^{T}. Then a minus sign is added, and a softmax function is used to get the weight matrix W according to Eq. 2, where Σₖ₌₁^{c} Wᵢₖ=1.

$${W}_{i j} = \frac{exp ( - {{XX}^{T}}_{ij} )}{{Σ}_{k = 1}^{c} exp ( - {{XX}^{T}}_{ik} )} \qquad ( Eq . 2 )$$

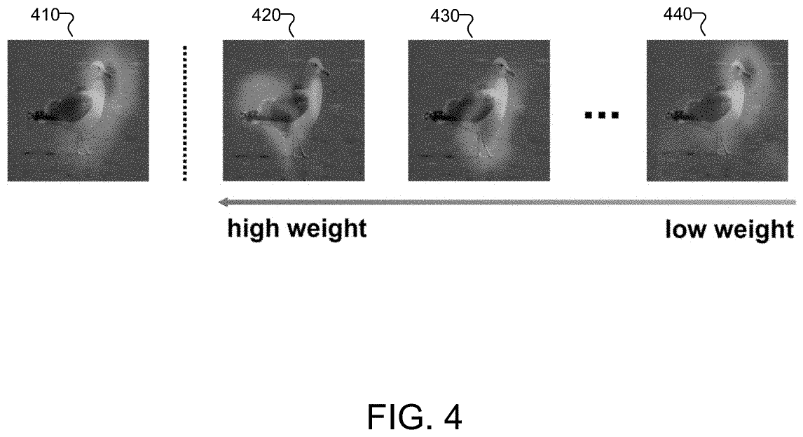

Now referring to FIG. 4, various images here illustrating a form of visualization of an example of the relationship between a referred channel (Xᵢ) in image 410 with other channels in a self-channel interaction module. In general, the channels with larger weights in an SCI weight matrix tend to be semantically complementary with the referred channel. In this example, the referred channel Xᵢ focuses on the head part; thus, the channels highlighting the complementary parts, like wings in image 420 and feet in image 430, would have larger weights than the channel with the head part in image 440.

Referring back to FIG. 3, it is worth noting that Yᵢ (the i^{th} channel of the resulting feature Y) is the computed interaction between Xᵢ and all the channels of X, e.g., according to Eq. 3. In this way, an SCI module can explore channel interaction information from all channels, which is an advantage of network 300 compared to many conventional systems.

Yᵢ=Wᵢ₁X₁+ . . . +W_{ic}X_{c} (Eq. 3)

It is also worth noting that feature Y may also be formalized as a non-local like operation according to Eq. 4, where ƒ(X,X)=softmax(−XX^{T})ϵ [symbol] ^{c×c}, and g(X)=Xϵ [symbol] ^{c×l}.

Y=ƒ(X,X)g(X) (Eq. 4)

Unlike other non-local operations that consider the interactions in spatial dimensions, the SCI module focuses on channel dimensions. More importantly, non-local operations tend to exploit the positive correlations between spatial positions. Similarly, many methods also try to explore positive channel interaction information. However, the SCI module focuses on negative correlations or negative channel interaction information, which enables network 300 to discover the semantically complementary channel information. Further, unlike other methods merely highlighting the discriminative features without considering the complementary clues, the disclosed SCI module can better explore those complementary clues to enhance channel-wise discriminative features. Even further, besides computing the channel-wise relationship within an image, the SCI module is to apply metric learning further to model the channel interplay between samples, which will be discussed in more detail.

Next, a discriminate feature (Z) is formed by aggregating both the newly generated feature (Y) and the original feature (X) from backbone 320, e.g., based on Eq. 5, where ϕ denotes a 3×3 convolutional layer in this embodiment. As can be appreciated by a skilled person, ϕ may use different sizes in different embodiments. Advantageously, even if the newly generated feature (Y) may not include all information from the original feature (X), the discriminate feature (Z) now would carry all information from the original feature (X), thus become more representative for the input image and more discriminative in comparing with other images.

Z=ϕ(Y)+X (Eq. 5)

Let M denote a feature map from backbone 320, and Mᵢ denote the iₜₕ dimension of M, M becomes the first-order feature of the image. A kₜₕ order feature of the image may be defined as that each element of the kₜₕ order feature is composed of a product of k elements from the first-order feature, e.g., each element of a second-order feature has a form of Mᵢ*Mⱼ, each element of a third-order feature has a form of Mᵢ*Mⱼ*Mₖ, or each element of a fourth-order feature has a form of Mᵢ*Mⱼ*Mₖ*Mₗ.

As applied to SCI module 330 or SCI module 340, X_{A} or X_{B} is a first-order feature. W_{A} or W_{B} is a second-order feature. Y_{A} or Y_{B} is a third-order feature. However, Z_{A} involves high order interactions of features, specifically, a summary of Y_{A} and X_{A} in this embodiment, e.g., each element of Z_{A} is composed of Mᵢ*Mⱼ*Mₖ+Mᵢ. Accordingly, Z_{A} or Z_{B} is referred to as a high-order feature in this disclosure.

In some embodiments, a high-order feature, e.g., Z_{A} or Z_{B}, is directly used for classification as a meaningful discriminate feature, e.g., via a softmax classifier. In some embodiments, deep metric learning is additionally adopted in network 300 to compute cross-sample channel-wise correlations by introducing contrastive constraints to the features enhanced by CCI module 350. In this way, network 300 can capture the subtle differences required for fine-grained classification.

To model the interaction between two images I_{A} and I_{B}, one approach is to impose the contrastive constraints on the features Z_{A} and Z_{B} enhanced by CCI module 350, and then measure their similarity. However, traditional deep metric learning approaches project an image into a fixed point in the learned embedding space and often fail to capture the subtle differences between two images. In contrast, in various embodiments, CCI module 350 is designed to learn the interactions between two images in a dynamic manner where the channels are emphasized by comparing to the feature channels computed from the contrastive image.

In some embodiments, for the contrastive channel interaction module to compute such relationships between two images, a subtraction operation is first applied between the SCI weight matrices of image I_{A} and I_{B} to generate CCI weight matrices W_{AB} and W_{BA}, e.g., according to Eq. 6, where η and γ are the weights learned by [Y_{A}, Y_{B}] and [Y_{B}, Y_{A}] through an FC layer ψ, i.e., η=ψ([Y_{A}, Y_{B}]), γ=ψ([Y_{B}, Y_{A}]), and ∥ denotes the absolute value. In other words, η and γ are learned by an FC layer controlling the encoded information computed from the contrastive image for highlighting differences.

W_{AB}=|W_{A}−ηW_{B}|,W_{BA}=|W_{B}−γW_{A}| (Eq. 6)

A CCI weight matrix indicates the amount of correlated information considered dynamically by an image to better distinguish itself from another. By using the subtraction operation, the CCI weight matrix suppresses the commonality and highlights the distinct channel relationships between two images. In alternative embodiments, instead of the subtraction operation, an addition, multiplication, or concatenation operation may be used.

Next, the CCI weight matrices W_{AB} and W_{BA} are applied to the features X_{A} and X_{B} to generate features Y_{A}′ and Y_{B}′, e.g., according to Eq. 7. Further, features Y_{A}′ and Y_{B}′ may be aggregated with features X_{A} and X_{B} to generate features Z′_{A} and Z′_{B}, e.g., according to Eq. 8.

Y_{A}′=W_{AB}X_{A},Y_{B}′=W_{BA}X_{B} (Eq. 7)

Z′_{A}=ϕ(Y′_{A})+X_{A},Z_{B}′=ϕ(Y_{B}′)+X_{B} (Eq. 8)

In connection to CCI module 350, X_{A} or X_{B} is a first-order feature. W_{AB} or W_{BA} is a second-order feature. Y_{A}′ or Y_{B}′ is a third-order feature. However, Z′_{A} and Z_{B}′ involve high order interactions of features, specifically, respective summaries of (Y_{A}′ and X_{A}) and (Y′_{B} and X_{B}) in this embodiment. Accordingly, Z′_{A} and Z_{B}′ are considered as high-order features in this disclosure.

Next, a loss (e.g., a contrastive loss in some embodiments) is applied to the high-order features (Z′_{A} and Z_{B}′) generated by CCI module 350, to push the samples of different classes away while pulling the positive image pairs closer in feature space 360. In this example, the positive pair (image 314 and image 318) will get closer in feature space 360, while the negative pair (image 312 and image 316) will get farther in feature space 360.

Suppose each batch contains N image pairs, i.e., 2N images, the contrastive loss is defined in some embodiments according to Eq. 9. The contrastive loss is simple and performs well in metric learning. In other embodiments, a triplet loss or other losses of metric learning may be used in network 300 as well.

$${L}_{c o n t} = \frac{1}{N} {\sum }_{A , B} ℓ ( {{Z}_{A}}^{′} , {{Z}_{B}}^{′} ) . \qquad ( Eq . 9 )$$

In some embodiments, [symbol] is defined per Eq. 10, where β is a predefined margin and ∥⋅∥ denotes the Euclidean distance, h is a fully-connected layer projecting features into an r-dimension space, i.e., H(Z)ϵ [symbol] ^{r}. r may be set to 512 in some embodiments. y_{AB} indicates whether the label of an image pair is the same or not, i.e., y_{AB}=1 denotes image I_{A} and image I_{B} come from the same class, while y_{AB}=0 means a negative pair.

$$ℓ = \{ \begin{matrix}{‖ h ( {{Z}_{A}}^{′} ) - h ( {{Z}_{B}}^{′} ) ‖}^{2} , & if {y}_{AB} = 1 \\ {max ( 0 , β - ‖ h ( {{Z}_{A}}^{′} ) - h ( {{Z}_{B}}^{′} ) ‖ )}^{2} , & if {y}_{AB} = 0\end{matrix} \qquad ( Eq . 10 )$$

Moreover, in some embodiments, a softmax loss is used for classification based on the feature Z (e.g., Z_{A} and Z_{B}) enhanced by CCI module 350. In various embodiments, after training, CCI module 350 is removed, and the softmax loss is replaced by a softmax layer during inference. During the training phrase, image pairs are used to train network 300. However, during the inference phase, only the SCI module is needed, and only a single image is required for image categorization.

During the training, let us denote the softmax loss as L_{soft}. The total loss Lₜₒₜₐₗ of network 300 may be defined per Eq. 11, where α is a hyper-parameter. A stochastic gradient method may be used to optimize Lₜₒₜₐₗ.

Lₜₒₜₐₗ=L_{soft}+α·L_{cont}, (Eq. 11)

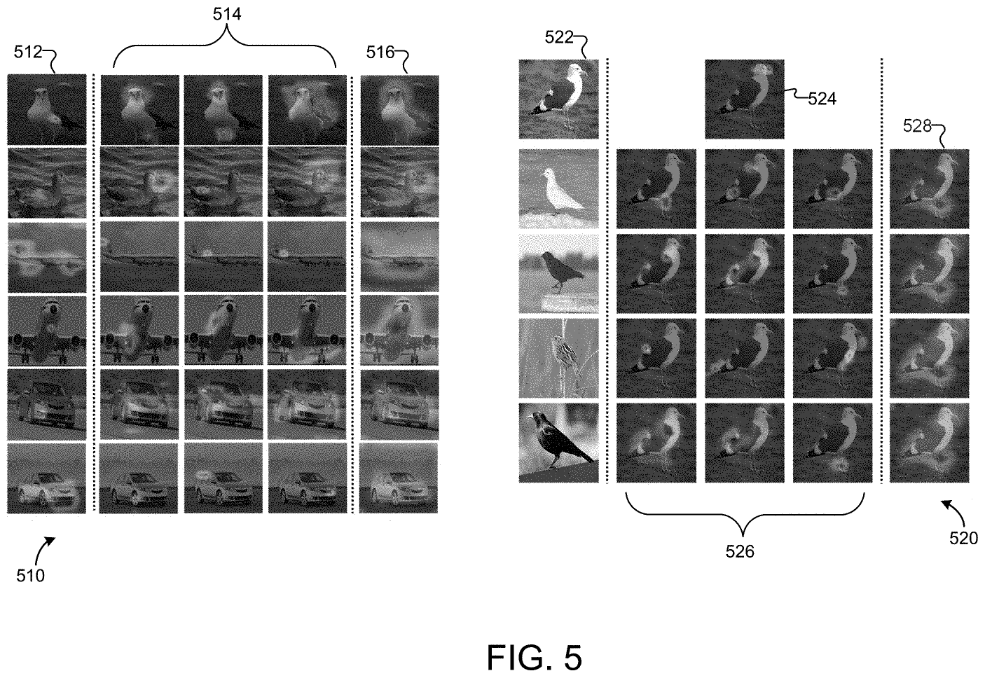

FIG. 5 are various images illustrating a form of qualitative visualization of respective results of a self-channel interaction module (e.g., SCI module 330 in FIG. 3) and a contrastive channel interaction module (e.g., CCI module 350 in FIG. 3). To better understand the intra-sample and inter-sample channel interactions modeled by network 300 in FIG. 3, group 510 and group 520 visualize the channel correlations and neural activations in exemplary SCI and CCI modules. Specifically, group 510 illustrates the visualization of channel activations before and after the SCI module on various datasets, including CUB, Cars, and Aircraft. Group 520 illustrates visualization on the results of a CCI module on the CUB dataset

Group 510 shows the visualization of an SCI module for images from three different datasets. Column 512 presents the activations of a randomly selected channel (assuming it is the i^{th} channel) before the SCI module. Column 514 includes the three most complementary channels in connection to respective randomly selected channels in column 512. In other words, these three channels correspond to the ones that have the largest values in the i^{th} row of the SCI matrix W, e.g., as defined in Eq. 2. Column 516 represents Yᵢ, which is the i^{th} channel of feature Y.

It is evident from group 510 that the top-3 complementary channels tend to capture different semantic for a referred channel. For instance, in the first example, the referred channel has a strong activation around wings, and its complementary channels focus more on head and tail regions. As a result, the attention feature channels are enhanced by this complementary information and also activates other discriminative parts. Note that the activations span most of the object parts in column 516. Such wide activations indicate that the SCI module effectively models the interactions among different channels, and combine their complementary but discriminative parts to produce more informative features, such as Y_{A} or Z_{A} in connection to FIG. 3.

Group 520 visualizes the application of the CCI module on the CUB-200-2011 dataset. Column 522 shows the original images. Column 526 illustrates the feature maps, where different regions are highlighted conditioned on different image pairs. Column 528 illustrates the contrastive attention activations by averaging all feature maps after CCI across channels. By way of example, the Salty Black Gull and the Ivory Cull have similar heads, and their features have weaker responses to the head. While comparing the Salty Black Gull with the Fish Crow, the activations near the head become stronger. For the other two bird species, their general appearance is significantly different from the Salty Black Gull. Correspondingly, the CCI module provides strong responses to many parts of these two birds. This result suggests that the CCI module has successfully focused on the key distinctions by modeling the interactions of channels between image pairs.

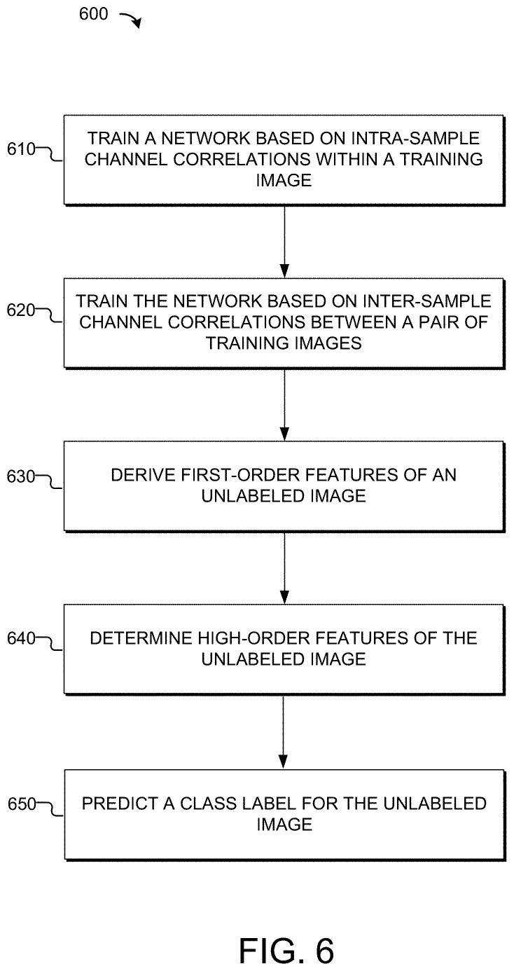

FIG. 6 is a flow diagram illustrating an exemplary process 600 of training and operating a channel interaction network, e.g., network 300 of FIG. 3. At block 610, the process is to train a network based on intra-sample channel correlations within a training image, e.g., based on an SCI. At block 620, the process is to train the network based on inter-sample channel correlations between a pair of training images, e.g., based on a CCI. At block 630, the process is to derive first-order feature of an unlabeled image, e.g., based on backbone 320 of FIG. 3. At block 640, the process is to determine the high-order feature of the unlabeled image, e.g., determine feature Z_{A} based on SCI module 330 of FIG. 3. At block 650, the process is to predict a class label for the unlabeled image based on the high-order feature via, e.g., a softmax layer. Further, various details and sub-processes of process 600 are discussed previously in connection with FIGS. 1-5.

Accordingly, we have described various aspects of the technologies for modeling and measuring compatibilities. Each block in process 600, and other processes described herein comprises a computing process that may be performed using any combination of hardware, firmware, or software. For instance, various functions may be carried out by a processor executing instructions stored in memory. The processes may also be embodied as computer-usable instructions stored on computer storage media or devices. The process may be provided by an application, a service, or a combination thereof.

It is understood that various features, sub-combinations, and modifications of the embodiments described herein are of utility and may be employed in other embodiments without reference to other features or sub-combinations. Moreover, the order and sequences of steps/blocks shown in the above example processes are not meant to limit the scope of the present disclosure in any way. The steps/blocks may occur in a variety of different sequences within embodiments hereof. Such variations and combinations thereof are also contemplated to be within the scope of embodiments of this disclosure.

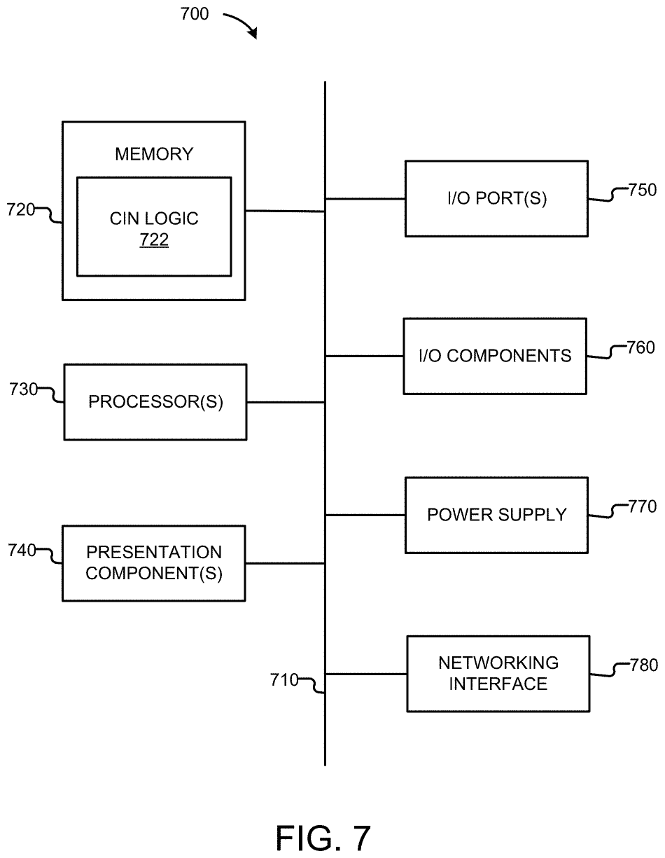

Referring to FIG. 7, an exemplary operating environment for implementing various aspects of the technologies described herein is shown and designated generally as computing device 700. Computing device 700 is but one example of a suitable computing environment and is not intended to suggest any limitation as to the scope of use of the technologies described herein. Neither should the computing device 700 be interpreted as having any dependency or requirement relating to any one or combination of components illustrated.

The technologies described herein may be described in the general context of computer code or machine-useable instructions, including computer-executable instructions such as program components, being executed by a computer or other machine. Generally, program components, including routines, programs, objects, components, data structures, and the like, refer to code that performs particular tasks or implements particular abstract data types. The technologies described herein may be practiced in a variety of system configurations, including handheld devices, consumer electronics, general-purpose computers, and specialty computing devices, etc. Aspects of the technologies described herein may also be practiced in distributed computing environments where tasks are performed by remote processing devices that are connected through a communications network.

With continued reference to FIG. 7, computing device 700 includes a bus 710 that directly or indirectly couples the following devices: memory 720, processors 730, presentation components 740, input/output (I/O) ports 750, I/O components 760, and an illustrative power supply 770. Bus 710 may include an address bus, data bus, or a combination thereof. Although the various blocks of FIG. 7 are shown with lines for the sake of clarity, in reality, delineating various components is not so clear, and metaphorically, the lines would more accurately be grey and fuzzy. For example, one may consider a presentation component such as a display device to be an I/O component. The inventors hereof recognize that such is the nature of the art and reiterate that the diagram of FIG. 7 is merely illustrative of an exemplary computing device that can be used in connection with different aspects of the technologies described herein. The distinction is not made between such categories as “workstation,” “server,” “laptop,” “handheld device,” etc., as all are contemplated within the scope of FIG. 7 and refers to “computer” or “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technologies for storage of information such as computer-readable instructions, data structures, program modules, or other data.

Computer storage media includes RAM, ROM, EEPROM, flash memory or other memory technologies, CD-ROM, digital versatile disks (DVD) or other optical disk storage, magnetic cassettes, magnetic tape, magnetic disk storage or other magnetic storage devices. Computer storage media does not comprise a propagated data signal. A computer-readable device or a non-transitory medium in a claim herein excludes transitory signals.

Communication media typically embodies computer-readable instructions, data structures, program modules, or other data in a modulated data signal such as a carrier wave or other transport mechanism and includes any information delivery media. The term “modulated data signal” means a signal that has its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 720 includes computer storage media in the form of volatile or nonvolatile memory. The memory 720 may be removable, non-removable, or a combination thereof. Exemplary memory includes solid-state memory, hard drives, optical-disc drives, etc. Computing device 700 includes processors 730 that read data from various entities such as bus 710, memory 720, or I/O components 760. Presentation component(s) 740 present data indications to a user or other device. Exemplary presentation components 740 include a display device, speaker, printing component, vibrating component, etc. I/O ports 750 allow computing device 700 to be logically coupled to other devices, including I/O components 760, some of which may be built-in.

In various embodiments, memory 720 includes, in particular, temporal and persistent copies of CIN logic 722. CIN logic 722 includes instructions that, when executed by processor 730, result in computing device 700 performing functions, such as, but not limited to, process 600 or other disclosed processes. In various embodiments, CIN logic 722 includes instructions that, when executed by processors 730, result in computing device 700 performing various functions associated with, but not limited to, various components in connection with system 130 or its components in FIG. 1, or network 300 or its components in FIG. 3.

In some embodiments, processors 730 may be packed together with CIN logic 722. In some embodiments, processors 730 may be packaged together with CIN logic 722 to form a System in Package (SiP). In some embodiments, processors 730 can be integrated on the same die with CIN logic 722. In some embodiments, processors 730 can be integrated on the same die with CIN logic 722 to form a System on Chip (SoC).

Illustrative I/O components include one or more microphones, joysticks, gamepads, satellite dishes, scanners, printers, display devices, wireless devices, controllers (such as a stylus, a keyboard, and a mouse), natural user interface (NUI), and the like. In aspects, a pen digitizer (not shown) and accompanying input instrument (also not shown but which may include, by way of example only, a pen or a stylus) are provided to capture freehand user input digitally. The connection between the pen digitizer and processor(s) 730 may be direct or via a coupling utilizing a serial port, parallel port, system bus, or other interface known in the art. Furthermore, the digitizer input component may be a component separate from an output component, such as a display device. In some aspects, the usable input area of a digitizer may coexist with the display area of a display device, be integrated with the display device, or may exist as a separate device overlaying or otherwise appended to a display device. Any and all such variations, and any combination thereof, are contemplated to be within the scope of aspects of the technologies described herein.

I/O components 760 include various GUIs, which allow users to interact with computing device 700 through graphical elements or visual indicators, such as various graphical elements illustrated in FIGS. 1-2. Interactions with a GUI usually are performed through direct manipulation of graphical elements in the GUI. Generally, such user interactions may invoke the business logic associated with respective graphical elements in the GUI. Two similar graphical elements may be associated with different functions, while two different graphical elements may be associated with similar functions. Further, the same GUI may have different presentations on different computing devices, such as based on the different graphical processing units (GPUs) or the various characteristics of the display.

Computing device 700 may include networking interface 780. The networking interface 780 includes a network interface controller (NIC) that transmits and receives data. The networking interface 780 may use wired technologies (e.g., coaxial cable, twisted pair, optical fiber, etc.) or wireless technologies (e.g., terrestrial microwave, communications satellites, cellular, radio and spread spectrum technologies, etc.). Particularly, the networking interface 780 may include a wireless terminal adapted to receive communications and media over various wireless networks. Computing device 700 may communicate with other devices via the networking interface 780 using radio communication technologies. The radio communications may be a short-range connection, a long-range connection, or a combination of both a short-range and a long-range wireless telecommunications connection. A short-range connection may include a Wi-Fi® connection to a device (e.g., mobile hotspot) that provides access to a wireless communications network, such as a wireless local area network (WLAN) connection using the 802.11 protocol. A Bluetooth connection to another computing device is a second example of a short-range connection. A long-range connection may include a connection using various wireless networks, including 1G, 2G, 3G, 4G, 5G, etc., or based on various standards or protocols, including General Packet Radio Service (GPRS), Enhanced Data rates for GSM Evolution (EDGE), Global System for Mobiles (GSM), Code Division Multiple Access (CDMA), Time Division Multiple Access (TDMA), Long-Term Evolution (LTE), 802.16 standards, etc.

The technologies described herein has been described in relation to particular aspects, which are intended in all respects to be illustrative rather than restrictive. While the technologies described herein are susceptible to various modifications and alternative constructions, certain illustrated aspects thereof are shown in the drawings and have been described above in detail. It should be understood, however, that there is no intention to limit the technologies described herein to the specific forms disclosed, but on the contrary, the intention is to cover all modifications, alternative constructions, and equivalents falling within the spirit and scope of the technologies described herein.

### EXPERIMENTS

Various experiments have been conducted to demonstrate the advantages or improvements made by the disclosed technologies. The following section describes the implementation details of the experiments on three publicly available datasets: CUB-200-2011, Stanford Cars, and FGVC Aircraft, where the disclosed system outperformed over current state-of-the-art. CUB-200-2011 has 11,788 images from 200 wild bird species. Stanford Cars includes 16,185 images in 196 classes. FGVC Aircraft contains about 10,000 images in 196 classes.

In the experiments, the disclosed approach is compared with ten baseline methods described as follows. The first four methods can be trained in one stage: (1) MAMC, which applies multi-attention multi-class constraints to enforce the correlations among different parts of objects; (2) CGNL, which captures the dependencies between positions across channels by a non-local operation to classify; (3) HBP, which uses hierarchical bilinear pooling framework to integrate multiple cross-layer bilinear features; (4) iSQRT-COV, which uses an iterative matrix square root normalization to do covariance pooling; (5) RA-CNN, which recursively learns discriminative region attention and region-based feature representation at multiple scales; (6) Boost-CNN, which uses a new boosting strategy to assemble weak classifiers for better performance; (7) DT-RAM, which uses a dynamic computational time model with reinforcement learning for recurrent visual attention; (8) MA-CNN, which uses multi-attention convolutional network including convolution, channel grouping, and part classification sub-networks; (9) DFL-CNN, which captures class-specific discriminative patches by learning a bank of convolutional filters; and (10) NTS, which uses local informative regions with a self-supervision mechanism.

In the disclosed experiments, ResNet-50 and ResNet-101 are used as the base networks. The network is pre-trained on ImageNet. The last pooling layer and fully-connected layer are removed. The input image size is 448×448, as in most state-of-the-art fine-grained categorization approaches. Data augmentation, including random cropping and horizontal flipping, is used during training. Only center cropping is involved in inference.

The network is trained for 100 epochs with SGD for all datasets. The base learning rate is set to 0.001, which annealed by 0.5 every 20 epochs. A batch size of 20 is used. Each batch contains four categories with five images in each category. And then, we randomly split these 20 images into 10 image pairs. The weight decay is set to 2×10⁻⁴. β is set to 0.5 empirically. α is set to 2.0. Top-1 accuracy is used as the evaluation metric.

Ablation studies are conducted to understand the impact of each component in the CIN. The performance and efficiency are compared in Table 1. ResNet-50 and ResNet-101 are used as the backbone.

TABLE 1
Ablation studies on CUB-200-2011

| Method | 1-Stage | ACC | Time (ms) |
|---|---|---|---|
| VGG-19 | ✓ | 80.2% | 22.1 |
| ResNet-50 | ✓ | 84.9% | 12.5 |
| ResNet-101 | ✓ | 85.4% | 22.4 |
| ResNet-50 + SE | ✓ | 85.7% | 14.0 |
| ResNet-50 + Pos-SCI | ✓ | 86.1% | 17.2 |
| ResNet-50 + Non-local | ✓ | 86.6% | 14.2 |
| ResNet-50 + MAMC | ✓ | 86.3% | 14.8 |
| ResNet-50 + CGNL | ✓ | 87.0% | 15.0 |
| ResNet-50 + SCI | ✓ | 87.1% | 17.2 |
| ResNet-50 + SCI + Cont | ✓ | 87.2% | 17.2 |
| ResNet-50 + NTS | X | 87.5% | 23.6 |
| ResNet-50 + CIN | ✓ | 87.5% | 17.2 |
| ResNet-101 + CIN | ✓ | 88.1% | 27.2 |

TABLE 2
Comparison results on CUB-200-2011,
FGVC Aircraft, and Stanford Cars.

| | | | | Acc(Stanford |
|---|---|---|---|---|
| Method | 1-Stage | Acc(CUB) | Acc(FGVC) | Cars) |
| MAMC | ✓ | 86.5% | — | 93.0% |
| CGNL | ✓ | 87.0% | — | — |
| HBP | ✓ | 87.1% | 90.3% | 93.7% |
| iSQRT-COV(8k) | ✓ | 87.3% | 89.5% | 91.7% |
| RA-CNN | X | 85.3% | — | 92.5% |
| Boost-CNN | X | 85.6% | 88.5% | 92.6% |
| DT-RAM | X | 86.0% | — | 93.1% |
| MA-CNN | X | 86.5% | 89.9% | 92.8% |
| DFL-CNN | X | 87.4% | 92.0% | 93.8% |
| NTS | X | 87.5% | 91.4% | 93.9% |
| CIN (ResNet-50) | ✓ | 87.5% | 92.6% | 94.1% |
| CIN (ResNet-101) | ✓ | 88.1% | 92.8% | 94.5% |

The SCI module mines complementary channels through exploring channel interactions, contributing to learning more discriminative features. As illustrated in Table 1, compared with ResNet-50 alone (84.9%), by merely adding the SCI module, ResNet-50+SCI obtains a performance improvement of 2.2%. Moreover, switching the interaction module from SCI to SE leads to a significant performance drop (87.1% vs. 85.7%). SE module only focuses on the most discriminative features and ignores others, while the SCI module utilizes the complementary channel knowledge to enhance all the features. Compared to the Non-local block and ResNet-50+Pos-SCI (SCI weight matrix W without the negative sign), which model the positive space and channel-wise information, respectively, the SCI module obtains better performance. Notice that the SCI module also outperforms CGNL (87.0%), which models the correlations between the positions of all channels. The SCI module exploits the negative interplay to find the channel-wise complementary information. In contrast, CGNL does not fully explore such information and computes the positive interaction to capture the closely related clues. These results demonstrate that: 1) for fine-grained image classification, the information contained in the channel dimension, as used in the disclosed CIN, is as powerful as complicated modeling across all dimensions; and 2) the complementary channel clues, as used in the disclosed CIN, can take full advantage of the channel interaction information.

The effectiveness of the CCI module is illustrated in Table 1 as well. Table 1 shows that the CCI module (e.g., ResNet-50+SCI+CCI) provides a 0.4% performance improvement compared to the method without a contrastive loss (ResNet-50+SCI). To further demonstrate the characteristics of the contrastive channel attention module, ResNet-50+SCI+Cont explicitly applies a contrastive loss to the features computed by the SCI module, i.e., η=0 and γ=0. As presented in Table 1, ResNet-50+SCI+Cont obtains a limited improvement with ResNet-50+SCI (87.2% vs. 87.1%). The reason might be that the common contrastive loss uses the same features of an image compared to any other image, which might reduce its ability to focus on the distinct differences between two images, while our CCI module is capable of highlighting the different regions. The results confirm that our CCI module has a strong capability for modeling the relationship between two images.

Further, inference time is reported on an Nvidia TITAN XP GPU with PyTorch implementation. As shown in Table 1, CIN introduces an overhead that is much smaller than that of two-stage methods (ResNet-50+NTS) and is comparable to the other one-stage approaches.

Next, the disclosed CIN is compared with state-of-the-art methods on the three publicly available datasets. Table 2 presents the classification results of CIN and state-of-the-art methods. First, the accuracy of the CIN is higher than all existing methods. Even with ResNet-50, the disclosed method achieves comparable results with NTS. However, NTS requires multiple stages for learning discriminative regions, resulting in more expensive costs on both time and space. Compared with the best one-stage method iSQRT-COV (8 k), the CIN method outperforms it by 0.2%. Note that the feature dimension of the CIN method (2 k) is significantly lower than iSQRT-COV (8 k). Moreover, the disclosed method improves HBP by 1.0%. The reason might be that HBP ignores the interaction between samples. It is notable that the backbone of HBP is VGG, while the accuracy of CIN with the same backbone is 85.6%. DFL-CNN achieves the best results on CUB (87.4%) with ResNet-50 backbone, while ResNet-50+CIN achieves a higher accuracy with only one stage. ResNet does not always outperform VGG.

Table 2 reports the performance on the FGVC Aircraft dataset. DFL-CNN achieves the highest accuracy of 92.0%, outperforming NTS with 91.4%. The accuracy of the CIN method is higher than existing methods, even with the backbone ResNet-50. The excellent results further confirm the superiority of the CIN method. It is worth noting that the accuracy of FGVC Aircraft is generally higher than that of CUB-200-2011, because images of CUB-200-2011 contain much more label noises and class-irrelevant background, while images in FGVC Aircraft have a relatively clean background, and airplanes often occupy a large portion of the image.

To verify the generalization ability of the disclosed CIN, another real-world dataset, the Stanford Cars, is also used in these experiments. Generally, the results in Table 2 related to Stanford Cars are consistent with those of the previous two datasets. Again, the disclosed CIN can achieve the highest accuracy compared with the state-of-arts.

TABLE 3
Integration with NTS.

| Dataset | CIN | NTS | NTS + CIN |
|---|---|---|---|
| CUB-200-2011 | 87.5% | 87.5% | 88.3% |
| FGVC Aircraft | 92.6% | 91.4% | 93.3% |
| Stanford Cars | 94.1% | 93.9% | 94.4% |

The disclosed modules are flexible, and they can be readily integrated into other frameworks to improve performance. In one experiment, the disclosed modules are integrated into the latest state-of-the-art method NTS, which is a two-stage framework by leveraging a region proposal networks to localize discriminative parts with weakly-supervised learning. The SCI module is integrated at the end of the feature extractor networks. As NTS will discover multiple regions out of sequence, thus the CCI is only applied to the whole feature stream. Table 3 shows the performance of the CIN method combined with NTS (NTS+CIN). As can be found, NTS+CIN achieves consistent performance improvements on all the three publicly available datasets compared with either NTS or CIN alone. The results further demonstrate the strong capability of the CIN network, which can improve the performance of various computer vision tasks when simply plugged into an existing framework.

### Examples

Lastly, by way of example, and not limitation, the following examples are provided to illustrate various embodiments, in accordance with at least one aspect of the disclosed technologies.

Examples in the first group comprise a method for image categorization, a computer system configured to perform the method, or a computer storage device storing computer-usable instructions that cause a computer system to perform the method.

One example in this group includes operations for training a network to determine features of a pair of training images based on respective channel weight matrixes of the pair of training images.

Another example may include the subject matter of one or more examples in this disclosure, and further includes operations for constructing a channel weight matrix of the respective channel weight matrixes based on intra-sample channel correlations within a training image of the pair of training images.

Another example may include the subject matter of one or more examples in this disclosure, and further includes operations for training the network by a contrastive constraint based on inter-sample channel correlations between the pair of training images.

Another example may include the subject matter of one or more examples in this disclosure, and further includes operations for constructing, via the network, a channel weight matrix of an unlabeled image; and predicting, based on the channel weight matrix of the unlabeled image, a class label for the unlabeled image.

Another example may include the subject matter of one or more examples in this disclosure, and further includes operations for modeling the intra-sample channel correlations to emphasize discriminative features of the training image, wherein the training image has only an image-level label.

Another example may include the subject matter of one or more examples in this disclosure, and further includes operations for utilizing the intra-sample channel correlations as a soft attention mechanism to learn discriminative features of the training image, wherein the soft attention mechanism is applied to first-order features of the training image derived from a neural network of the network.

Another example may include the subject matter of one or more examples in this disclosure, and further includes operations for determining, based on the respective channel weight matrixes, the features of the pair of training images as high-order features from first-order features of the pair of training images, the first-order features being directly derived from a neural network of the network.

Another example may include the subject matter of one or more examples in this disclosure, and further includes operations for modeling the inter-sample channel correlations between the pair of training images based on a subtraction operation between the respective weight matrixes of the pair of training images.

Another example may include the subject matter of one or more examples in this disclosure, and further includes operations for modeling the inter-sample channel correlations between the pair of training images with an inter-sample channel weight matrix that emphasizes distinct channel relationships specific to the pair of training images.

Another example may include the subject matter of one or more examples in this disclosure, and further includes operations for determining respective high-order features of the pair of training images based on respective inter-sample channel weight matrixes of the pair of training images.

Another example may include the subject matter of one or more examples in this disclosure, and further includes operations for constructing the contrastive constraint based on a contrastive loss, a triplet loss, or another loss of metric learning applied to the respective high-order features of the pair of training images.

Another example may include the subject matter of one or more examples in this disclosure, and further includes operations for constructing the channel weight matrix of the unlabeled image based on semantically complementary channel information of the unlabeled image.

Another example may include the subject matter of one or more examples in this disclosure, and further specify that the unlabeled image comprises a product, and the class label comprises a product identifier corresponding to the product.

Another example may include the subject matter of one or more examples in this disclosure, and further includes operations for recognizing a product based on the trained network.

Another example may include the subject matter of one or more examples in this disclosure, and further includes operations for performing a type of computer vision task based on the trained CIN.

Examples in the second group comprise a method for image categorization, a computer system configured to perform the method, or a computer storage device storing computer-usable instructions that cause a computer system to perform the method.

One example in this group includes operations for extracting the first-order feature of an unlabeled image from a neural network.

Another example may include the subject matter of one or more examples in this disclosure, and further includes operations for determining a high-order feature of the unlabeled image based on the first-order features of the unlabeled image and intra-sample channel correlations within the unlabeled image.

Another example may include the subject matter of one or more examples in this disclosure, and further includes operations for predicting a class label for the unlabeled image based on the high-order feature of the unlabeled image.

Another example may include the subject matter of one or more examples in this disclosure, and further includes operations for applying a softmax loss to the high-order feature of the unlabeled image to predict the class label.

Another example may include the subject matter of one or more examples in this disclosure, and further includes operations for determining a second-order feature of the unlabeled image based on a matrix multiplication operation between the first-order feature and a transpose of the first-order feature.

Another example may include the subject matter of one or more examples in this disclosure, and further includes operations for determining a third-order feature of the unlabeled image based on a matrix multiplication operation between the first-order feature and the second-order feature.

Another example may include the subject matter of one or more examples in this disclosure, and further includes operations for determining the high-order features of the unlabeled image based on an element-wise addition between the first-order feature and the third-order feature.

Another example may include the subject matter of one or more examples in this disclosure, and further includes operations for determining respective high-order features of a pair of training images based on respective inter-sample channel weight matrixes of the pair of training images.

Another example may include the subject matter of one or more examples in this disclosure, and further includes operations for constructing a contrastive constraint based on a contrastive loss applied to the respective high-order features of the pair of training images, and training the neural network based on the contrastive constraint.

Another example may include the subject matter of one or more examples in this disclosure, and further includes operations for determining the third-order feature of the training image based on a matrix multiplication operation between the first-order feature and an inter-sample channel weight matrix of the training image.

Another example may include the subject matter of one or more examples in this disclosure, and further includes operations for determining the high-order feature based on an element-wise addition operation between the first-order feature and the third-order feature.

Another example may include the subject matter of one or more examples in this disclosure, and further specifies that a high-order feature of a training image includes a summary of a first-order feature and a third-order feature of the training image.

Examples in the third group comprise a system. One example in this group includes a camera to capture an image of a product; and a neural network, operatively connected to the camera, trained to recognize the product or a class label of the image.

Another example may include the subject matter of one or more examples in this disclosure, and further specifies that the system has a display to present product information based on the class label of the image or the product.

Another example may include the subject matter of one or more examples in this disclosure, and further specifies that the neural network is trained to derive first-order features of the image.

Another example may include the subject matter of one or more examples in this disclosure, and further specifies that the neural network is trained to determine high-order features of the image based on the first-order features of the image and a channel weight matrix having semantically complementary channel information of the image.

Another example may include the subject matter of one or more examples in this disclosure, and further specifies that the neural network is trained to recognize the product based on the high-order features of the image.

Another example may include the subject matter of one or more examples in this disclosure, and further specifies that the neural network is trained to learn the semantically complementary channel information from channel-wise interactions in the image.

Another example may include the subject matter of one or more examples in this disclosure, and further specifies that the neural network is trained to encode the semantically complementary channel information into the first-order features of the image.

Another example may include the subject matter of one or more examples in this disclosure, and further specifies that the channel weight matrix has a first weight for a first channel that is negatively correlated to a reference channel, and a second weight for a second channel that is positively correlated to the reference channel, and the first weight is greater than the second weight.

Another example may include the subject matter of one or more examples in this disclosure, and further specifies that the neural network is trained to apply a softmax to the high-order features of the image to predict a class label of the image.

Another example may include the subject matter of one or more examples in this disclosure, and further specifies that the camera is configured to capture the image of the product on a checkout machine of a retail store.

Another example may include the subject matter of one or more examples in this disclosure, and further specifies that the system is a checkout machine or a part thereof.

What is claimed is:

1. A computer-implemented method for image categorization, comprising:
training a network to determine features of a pair of training images based on respective channel weight matrixes of the pair of training images, at least one of the respective channel weight matrixes being constructed based on intra-sample channel correlations within a training image of the pair of training images, the network being further trained by a contrastive constraint based on inter-sample channel correlations between the pair of training images;
constructing, via the network, a channel weight matrix of an unlabeled image; and
predicting, based on the channel weight matrix of the unlabeled image, a class label for the unlabeled image.

2. The method of claim 1, further comprising:
modeling the intra-sample channel correlations to emphasize discriminative features of the training image, wherein the training image has only an image-level label.

3. The method of claim 1, further comprising:
utilizing the intra-sample channel correlations as a soft attention mechanism to learn discriminative features of the training image, wherein the soft attention mechanism is applied to a first-order feature of the training image derived from a neural network of the network.

4. The method of claim 1, further comprising:
determining, based on the respective channel weight matrixes, the features of the pair of training images as respective high-order features from respective first-order features of the pair of training images, the respective first-order features being directly derived from a neural network of the network.

5. The method of claim 1, further comprising:
modeling the inter-sample channel correlations between the pair of training images based on a subtraction operation between the respective weight matrixes of the pair of training images.

6. The method of claim 1, further comprising:
modeling the inter-sample channel correlations between the pair of training images with an inter-sample channel weight matrix that emphasizes distinct channel relationships specific to the pair of training images.

7. The method of claim 1, further comprising:
determining respective high-order features of the pair of training images based on respective inter-sample channel weight matrixes of the pair of training images; and
constructing the contrastive constraint based on a contrastive loss, a triplet loss, or another loss of metric learning applied to the respective high-order features of the pair of training images.

8. The method of claim 1, wherein the constructing further comprises constructing the channel weight matrix of the unlabeled image based on semantically complementary channel information of the unlabeled image.

9. The method of claim 1, wherein the unlabeled image comprises a product, and the class label comprises a product identifier corresponding to the product.

10. A computer-readable storage device encoded with instructions that, when executed, cause one or more processors of a computing system to perform operations of image categorization, comprising:
extracting a first-order feature of an unlabeled image from a neural network;
determining a high-order feature of the unlabeled image based on the first-order feature of the unlabeled image and intra-sample channel correlations within the unlabeled image; and
predicting a class label for the unlabeled image based on the high-order feature of the unlabeled image.

11. The computer-readable storage device of claim 10, wherein the operations further comprising:
applying a softmax loss to the high-order feature of the unlabeled image to predict the class label.

12. The computer-readable storage device of claim 10, wherein the operations further comprising:
determining a second-order feature of the unlabeled image based on a matrix multiplication operation between the first-order feature and a transpose of the first-order feature; and
determining a third-order feature of the unlabeled image based on a matrix multiplication operation between the first-order feature and the second-order feature.

13. The computer-readable storage device of claim 12, wherein the operations further comprising:
determining the high-order feature of the unlabeled image based on an element-wise addition between the first-order feature and the third-order feature.

14. The computer-readable storage device of claim 10, wherein the operations further comprising:
determining respective high-order features of a pair of training images based on respective inter-sample channel weight matrixes of the pair of training images;
constructing a contrastive constraint based on a contrastive loss applied to the respective high-order features of the pair of training images; and
training the neural network based on the contrastive constraint.

15. The computer-readable storage device of claim 14, wherein a high-order feature of a training image of the pair of training images includes a summary of a first-order feature of the training image and a third-order feature of the training image, wherein the operations further comprising:
determining the third-order feature of the training image based on a matrix multiplication operation between the first-order feature and an inter-sample channel weight matrix of the training image; and
determining the high-order feature of the training image based on an element-wise addition operation between the first-order feature of the training image and the third-order feature of the training image.

16. A system, comprising:
a camera to capture an image of a product; and
a neural network, operatively connected to the camera, trained to:
derive a first-order feature of the image;
determine a high-order feature of the image based on the first-order feature of the image and a channel weight matrix having semantically complementary channel information of the image; and
recognize the product based on the high-order feature of the image.

17. The system of claim 16, wherein the neural network is further trained to:
learn the semantically complementary channel information from channel-wise interactions in the image; and
encode the semantically complementary channel information into the first-order feature of the image.

18. The system of claim 16, wherein the channel weight matrix has a first weight for a first channel that is negatively correlated to a reference channel, and a second weight for a second channel that is positively correlated to the reference channel, and the first weight is greater than the second weight.

19. The system of claim 16, wherein the neural network is further trained to:
apply a softmax loss to the high-order feature of the image to predict a class label of the image.

20. The system of claim 19, wherein the camera is configured to capture the image of the product on a checkout machine of a store, and the system further comprising:
a display to present product information based on the class label of the image.
